(19) United States
(12) Patent Application Publication
(10) Pub. No.: US 2011/0289824 A1
(43) Pub. Date: Dec. 1, 2011

(54) COMPOUNDS, METHODS, AND DEVICES FOR DETECTING AND/OR TREATING INSECT INFESTATION

(76) Inventors: Tai-Teh Wu, Chapel Hill, NC (US); Kenneth Haynes, Lexington, KY (US); Joe Harold Hope, III, Mebane, NC (US)

(21) Appl. No.: 12/789,873

(22) Filed: May 28, 2010

(51) Int. Cl. A01M 1/20; A01P 19/00; A01P 7/04; A01N 35/10

(52) U.S. Cl. 43/132.1; 424/84

(57) ABSTRACT

Compounds, compositions, kits, devices, and methods of attracting, arresting, aggregating, detecting, eradicating, controlling, or killing an insect, such as a bed bug, by utilizing insect attractant, aggregating, or arresting compounds and compositions is provided. A suitable device comprises a pair of plates separated by an internal spacing sized to permit entry into the detection device by one or more insects. Also disclosed is a method for readily detecting insects such as bed bugs in a multiple areas such as in multiple hotel rooms, areas where animals are housed, or the like.

### FIELD

This disclosure relates to compounds, compositions, methods, and devices for attracting, arresting, aggregating, eradicating, and/or detecting insects such as those that feed on the blood of warm-blooded hosts including bed bugs.

### BACKGROUND

Bed bugs are small insects that feed solely on the blood of animals. The common bed bug, Cimex lectularius, is the species of bed bug that has most adapted to living with human beings. Adult bed bugs are about ¼-inch or about 6 millimeters long, 5 to 6 millimeters wide, and reddish-brown with oval, flattened bodies. The immature nymphs are similar in appearance to the adults but smaller and lighter in color.

Bed bugs do not fly but they can move very quickly over surfaces. Female bed bugs lay their eggs in secluded areas and can deposit up to five eggs per day, and as many as 500 during a lifetime. Bed bugs can survive for extended periods without feeding. For example, nymphs can survive months without feeding and the adults can survive more than a year. As a result, infestations are not likely to be eliminated by the absence of a host in the area of concern.

Bed bugs obtain their sustenance by drawing blood through an elongated beak. They may feed on a human being for 3 to 10 minutes, although the human being is not likely to feel the bite. After the bite, the human victim often experiences an itchy welt or swelling in the area of the bite. Because some victims do not have any reaction, or only a minimal reaction to a bed bug bite, infestations may go long periods without being detected. New bed bug infestations originate from a bed bug being carried into a new area, such as by clinging to possessions which are easily transported, for example, clothing, sheets, and other items. Bed bug bugs are also commonly introduced to new areas on used furniture, mattresses, or by way of suitcases. Additionally, the ability of bed bugs to disperse by walking can spread an infestation between nearby units in a multi-unit dwelling (such apartments, nursing homes, and motel/hotel rooms). As a consequence, living areas where the turnover of occupants is high, such as hotels or apartments, are especially vulnerable to bed bug infestations.

For the foregoing reasons, bed bugs are often difficult to detect and eradicate. Pest management professionals (PMPs) and pesticides are typically required, necessitating removal of non-essential objects from a room, removal of bed bugs and eggs through vacuuming and/or steaming, and then application of pesticides to likely hiding areas. Because treatment for bed bug infestation is intrusive, disruptive to normal business operations and expensive, early detection and treatment of bed bugs and continuous monitoring for the presence of bed bugs is highly desirable. If early detection is made, appropriate steps can be taken before infestation becomes established.

What is needed, therefore, is a detection device for monitoring bed bug infestation which is attractive to bed bugs, easy to handle, discrete, and deployable across a wide range of areas, for example, in hotels and other lodging locations that experience frequent turnover of occupancy. Also needed are compounds and compositions capable of attracting, arresting, and/or aggregating insects as well as treating insect infestation. Such compounds and compositions may be used together with detection devices or traps to treat and detect insect infestation.

### SUMMARY

The disclosure provides methods of attracting, arresting, aggregating, detecting, eradicating, controlling, and/or killing an insect, such as a bed bug, by utilizing a compound or composition described herein. The disclosure also provides for compositions, kits, and devices comprising compounds described herein.

The disclosure also provides for bait compositions comprising an insect attractant, arresting, and/or aggregating compound or composition described herein. In an aspect, the disclosure provides for a method of treating insect infestation and/or determining the presence or absence of an insect, by providing a bait material comprising a compound according to the instant disclosure. The bait composition may be used in any of the methods described herein and may optionally include an insecticide.

In another aspect, the disclosure provides for a detection device or trap containing a compound described herein. In an aspect, a bait composition can be used with the detection device or trap. In an aspect, the disclosure provides for a detection device for monitoring the presence or absence of bed bugs and/or infestation, comprising a first plate and a second plate, wherein the first plate and the second plate are separated by an internal spacing sized to permit entry into the detection device by one or more bed bugs; and an insect attractant, arresting, and/or aggregating compound described herein.

In an aspect, the disclosure provides for a support material comprising an insect attractant, arresting, and/or aggregating compound or composition described herein. In one aspect, the support material is coated or impregnated with a compound or composition described herein. The support material may be, for example, an absorbent material, wood, cardboard, corrugated cardboard, cotton, wallpaper, paper, plastic, a plastic tube, or metal.

In an aspect, the disclosure provides for a method of luring or arresting an insect into an area treated with a compound or composition described herein. In one aspect, the treated area is a support material capable of being coated or impregnated with a compound.

In an aspect, an insect attractant, arresting, and/or aggregating compound or composition described herein may be combined with an insecticide or pheromone. In another aspect, the insecticide is selected from the group consisting of carbamates, pyrethroids, phenylpyrazoles, such as fipronil or ethiprole, chloronicotinyles, imidacloprid, acetamiprid, thiacloprid, thiamethoxam, nitenpyram, clothianidin, oxadiazines, anthranilic diamides, butenolides, sulfoximines, indoxacarb, and rynaxypyr. In another aspect, the compositions, devices, support materials, and/or methods do not include an insecticide compound together with an attractant, aggregation, or arrestant compound or composition described herein.

In an aspect, the insect attractant, arresting, or aggregating compound is selected from one or more compounds of Formula I-XV or Table 1. The disclosure also provides for an insecticidal active compound Formula I-XV or Table 1.

In another aspect, the compound is selected from one or more of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide. In yet another aspect, the compound is 2-heptanone oxime, 2-hexanone oxime, or 2-Nonanone oxime.

In an aspect, the disclosure provides for a method of attracting, arresting, aggregating, detecting, eradicating, controlling, and/or killing an insect, such as a bed bug, by utilizing a compound or composition as described herein with a compound selected from the group consisting of cholesterol, (E)-2-hexenal, (E)-2-hexenol, (E,E)-2,4-hexadienal, or (E)-2-octenal.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### BRIEF DESCRIPTION OF THE DRAWINGS

FIG. 1 provides an overview of a two-choice bioassay experiment.

FIG. 2 provides a perspective view of a detection device according to one aspect.

FIG. 3 provides a front view of the detection device according to FIG. 2.

FIG. 4 provides a side view of the detection device according to FIG. 2.

FIG. 5 provides a top view of the detection device according to one aspect of FIG. 2.

### DETAILED DESCRIPTION

In one aspect, the disclosure provides a method of attracting, arresting, aggregating, detecting, eradicating, controlling, and/or killing an insect by utilizing a compound or composition described herein. The disclosure also provides for a method of attracting, arresting, aggregating, detecting, eradicating, controlling, or killing an insect by providing a trap, support material, or detection device together with a compound or composition described herein. In an aspect, the insect is a bed bug. In another aspect, the bed bug is from the species Cimex lectularius. While the instant disclosure focuses on utilizing the feces or fecal extract of bed bugs for identification of suitable compounds to utilize attractants, arresting, and/or aggregation compounds as well as compounds that influence the behavior of bed bugs, the instant disclosure could well be translated to be utilized with other related, blood-feeding arthropods or insects because species that share a similar food source and/or similar benefits of aggregations and are related may also share common attractants, arrestants, aggregation compounds or other pheromones.

In an aspect, insect attractant, arresting, and/or aggregating compounds and compositions containing, for example, an oxime, hydrazone, amidine, imino, and/or imine functional group are described herein. In an aspect, the disclosure provides a method of attracting, arresting, aggregating, detecting, eradicating, controlling, and/or killing an insect by utilizing a compound having an oxime, hydrazone, amidine, imino, or imine functional group.

In an aspect, the disclosure provides for a compound, composition, device, support material, kit, as well a method of attracting, arresting, aggregating, detecting, eradicating, controlling, and/or killing an insect by utilizing a compound of Formula I:

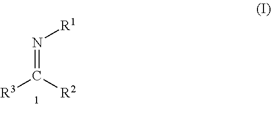

in which,
R¹ represents H, OH, NH₂, substituted or non substituted O—C₁-C₃-alkyl, substituted or non substituted O—C₁-C₆-alkyl, substituted or non substituted C₁-C₆-alkyl, N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃;
R² and R³ are independently selected from H, methyl, ethyl, propyl, isopropyl, cyclopropyl, butyl, tert-butyl, pentyl, tert-butyl, pentyl, hexyl, heptyl, octyl, nonyl, decyl, OH, COOH, substituted or non substituted C₂-C₁₂-alkyl, substituted or non substituted C₂-C₁₂-alkenyl, substituted or non substituted C₂-C₁₂-alkynyl, substituted or non substituted C₃-C₈-cycloalkyl, allyl, O-allyl, C₁-C₁₂-halogenalkyl, a halogen, tri-fluoromethyl, monohalo, polyhalo, perhaloalkyl, substituted or non substituted C₂-C₁₂-alkenyl, substituted or non substituted C₂-C₆-alkynyl, or where R² and R³ are linked together to form a (CH₂)₃, (CH₂)₄, (CH₂)₅, (CH₂)₆, (CH₂)₇, or a (CH₂)₈ ring structure; and/or

optically active and/or geometric isomers and/or salts thereof.

In a further aspect, a compound of Formula I is as follows:
R¹ represents H, OH, NH₂, substituted or non substituted O—C₁-C₃-alkyl, or substituted or non substituted O—C₁-C₆-alkyl;
R² and R³ are independently selected from H, methyl, ethyl, propyl, isopropyl, cyclopropyl, butyl, tert-butyl, pentyl, substituted or non substituted C₂-C₆-alkyl, substituted or non substituted C₂-C₆-alkenyl, a substituted or non substituted C₂-C₆-alkynyl substituted or non substituted C₃-C₆-cycloalkyl, allyl, O-allyl, C₁-C₆-halogenalkyl, a halogen, trifluoromethyl, substituted or non substituted C₂-C₆-alkenyl, substituted or non substituted C₂-C₆-alkynyl, or where R² and R³ are linked together to form a (CH₂)₃, (CH₂)₄, (CH₂)₅, (CH₂)₆, (CH₂)₇, or (CH₂)₈ ring structure; and/or

optically active and/or geometric isomers and/or salts thereof.

In a further aspect, a compound of Formula I is as follows:
R¹ represents H, OH, or NH₂;
R² and R³ are independently selected from H, methyl, ethyl, propyl, isopropyl, cyclopropyl, butyl, tert-butyl, substituted or non substituted C₂-C₆-alkyl, substituted or non substituted C₂-C₆-alkenyl, a substituted or non substituted C₂-C₆-alkynyl, or a substituted or non substituted C₃-C₆-cycloalkyl; and/or

optically active and/or geometric isomers and/or salts thereof.

In a further aspect, a compound of Formula I is as follows:
R¹ represents H, OH, or NH₂;
R² and R³ are independently selected from methyl, ethyl, propyl, isopropyl, cyclopropyl, butyl, tert-butyl, pentyl, hexyl, heptyl, octyl, nonyl, decyl, and substituted or non substituted C₂-C₆-alkyl; and/or

optically active and/or geometric isomers and/or salts thereof.

In a further aspect, a compound of Formula I is as follows:
R¹ represents OH;
R² and R³ are independently selected from methyl, ethyl, propyl, isopropyl, butyl, tert-butyl, hexyl, septyl, oxyl, nonyl, decyl substituted or non substituted C₂-C₆-alkyl; and/or

optically active and/or geometric isomers and/or salts thereof.

In a further aspect, a compound of Formula I is as follows:
R¹ represents H, OH, or NH₂;
R² is methyl, ethyl, propyl;
R³ is methyl, ethyl, propyl, isopropyl, butyl, tert-butyl, pentyl, hexyl, heptyl, octyl, nonyl, decyl or substituted or non substituted C₂-C₁₂-alkyl; and/or

optically active and/or geometric isomers and/or salts thereof.

In a further aspect, a compound of Formula I is as follows:
R¹ represents OH;
R² is methyl;
R³ is butyl, tert-butyl, pentyl, hexyl, heptyl, octyl, and/or

optically active and/or geometric isomers and/or salts thereof.

In a further aspect, a compound of Formula I is as follows:
R¹ represents OH;
R² is methyl;
R³ is pentyl,

optically active and/or geometric isomers and/or salts thereof.

In a further aspect, a compound of Formula I is as follows:
R¹ represents OH;
R² is trifluoromethyl;
R³ is butyl, tert-butyl, pentyl, hexyl, heptyl, octyl, and/or

optically active and/or geometric isomers and/or salts thereof.

In an aspect, the disclosure provides for a compound, composition, device, support material, kit, as well a method of attracting, arresting, aggregating, detecting, eradicating, controlling, or killing an insect by utilizing a compound of Formula II:

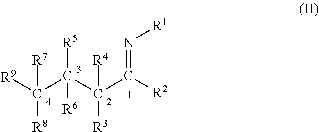

in which,
R¹ represents H, OH, NH₂, substituted or non substituted O—C₁-C₃-alkyl, substituted or non substituted O—C₁-C₆-alkyl, substituted or non substituted C₁-C₆-alkyl N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃;
R² represents H, methyl, ethyl, propyl, isopropyl, cyclopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, substituted or non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, monohalo, polyhalo, perhaloalkyl, substituted or non substituted C₂-C₆-alkenyl, substituted or non substituted C₂-C₆-alkynyl;
R³ represents substituted H, C₂-C₆-alkyl, substituted or non substituted C₃-C₆-cycloalkyl, substituted or non substituted C₂-C₆-alkenyl, substituted or non substituted C₂-C₆-alkynyl, a halogen, or substituted or non substituted O—C₁-C₃-alkyl;
R⁴ represents H, substituted C₂-C₆-alkyl, substituted or non substituted C₃-C₆-cycloalkyl, substituted or non substituted C₂-C₆-alkenyl, substituted or non substituted C₂-C₆-alkynyl, a halogen, or substituted or non substituted O—C₁-C₃-alkyl;
R⁵ represents H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, or substituted or non substituted O—C₁-C₃-alkyl;
R⁶ represents H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alky;
R⁷ represents H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl, or R⁵ and R⁷ are linked together to form a (CH₂)₃, (CH₂)₄, (CH₂)₅, or (CH₂)₆ ring structure;
R⁸ represents H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl, or R⁶ and R⁸ are linked together to form a (CH₂)₃, (CH₂)₄, (CH₂)₅, or (CH₂)₆ ring structure; and
R⁹ represents H, methyl, ethyl, propyl, isopropyl, butyl, tert-butyl, substituted or non substituted C₁-C₆-alkyl, substituted or non substituted C₃-C₆-cycloalkyl, substituted or non substituted C₂-C₆-alkenyl, substituted or non substituted C₂-C₆-alkynyl, a halogen atom, halogeno-C₁-C₃-alkyl, substituted or non substituted O—C₁-C₃-alkyl, cyano; R⁸ and R⁹ are linked together to form a (CH₂)₃, (CH₂)₄, (CH₂)₅, or (CH₂)₆ ring structure; and/or

optically active and/or geometric isomers and/or salts thereof.

In a further aspect, a compound of Formula II is as follows:
R¹ represents H, OH, or NH₂;
R² represents methyl, ethyl, propyl, isopropyl, cyclopropyl, butyl, tert-butyl, trifluoromethyl, substituted or non substituted C₂-C₆-alkyl, substituted or non substituted C₃-C₆-cycloalkyl, substituted or non substituted C₂-C₆-alkenyl, or a substituted or non substituted C₂-C₆-alkynyl;
R³ represents H, methyl, ethyl, propyl, cyclopropyl, or isopropyl;
R⁴ represents H, methyl, ethyl, propyl, cyclopropyl, or isopropyl;
R⁵ represents H, methyl, ethyl, propyl, cyclopropyl, isopropyl, substituted or non substituted C₂-C₆-alkyl;
R⁶ represents H, methyl, ethyl, propyl, cyclopropyl, isopropyl, substituted or non substituted C₂-C₆-alkyl;
R⁷ represents H, methyl, ethyl, propyl, cyclopropyl, isopropyl, substituted or non substituted C₂-C₆-alkyl, or R⁵ and R⁷ are linked together to form a (CH₂)₃, (CH₂)₄, (CH₂)₅, or (CH₂)₆ ring structure;
R⁸ represents H, methyl, ethyl, propyl, cyclopropyl, isopropyl, substituted or non substituted C₂-C₆-alkyl, or R⁶ and R⁸ are linked together to form a (CH₂)₃, (CH₂)₄, (CH₂)₅, or (CH₂)₆ ring structure; and
R⁹ represents H, methyl, ethyl, propyl, cyclopropyl, isopropyl, butyl, tert-butyl, substituted or non substituted C₁-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl or cyano; R⁸ and R⁹ are linked together to form a (CH₂)₃, (CH₂)₄, (CH₂)₅, or (CH₂)₆ ring structure; and/or

optically active and/or geometric isomers and/or salts thereof.

In a further aspect, a compound of Formula II is as follows:
R¹ represents H, OH or NH₂;
R² represents methyl, ethyl, or propyl;
R³ represents H, methyl, or ethyl;
R⁴ represents H, methyl, or ethyl;
R⁵ represents H, methyl, ethyl;
R⁶ represents H, methyl, ethyl;
R⁷ represents H, methyl, ethyl, propyl, or R⁵ and R⁷ are linked together to form a (CH₂)₃, (CH₂)₄, (CH₂)₅, or (CH₂)₆ ring structure;
R⁸ represents H, methyl, ethyl, propyl, or R⁵ and R⁷ are linked together to form a (CH₂)₃, (CH₂)₄, (CH₂)₅, or (CH₂)₆ ring structure; and
R⁹ represents methyl, ethyl, propyl, isopropyl, butyl, tert-butyl; and/or

optically active and/or geometric isomers and/or salts thereof.

In a further aspect, a compound of Formula II is as follows:
R¹ represents OH or NH₂;
R² represents methyl or ethyl;
R³ represents H; R⁴ represents H; R⁵ represents H; R⁶ represents H; R⁷ represents H; R⁸ represents H;
R⁹ represents methyl, ethyl, propyl, isopropyl, butyl, tert-butyl, pentyl; and/or

optically active and/or geometric isomers and/or salts thereof.

In a further aspect, a compound of Formula II is as follows:
R¹ represents OH;
R² represents methyl;
R³, R⁴, R⁵, R⁶, R⁷, or R⁸ are independently selected from represent H or methyl;
R⁹ represents methyl, ethyl, or propyl; and/or

optically active and/or geometric isomers and/or salts thereof.

In a further aspect, a compound of Formula II is as follows:
R¹ represents OH;
R² represents methyl;
R³, R⁴, R⁵, R⁶, R⁷, or R⁸ are H;
R⁹ represents methyl, ethyl, or propyl; and/or

optically active and/or geometric isomers and/or salts thereof.

In another aspect, the disclosure provides for a compound, composition, device, support material, kit, as well a method of attracting, arresting, aggregating, detecting, eradicating, controlling, or killing an insect by utilizing a compound of Formula III, IV, or V:

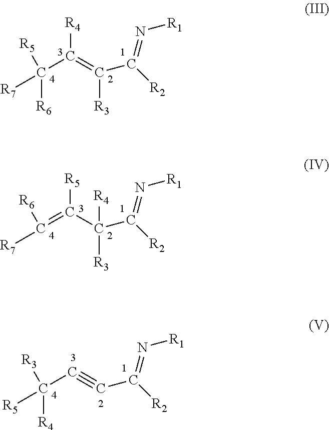

in which,
R¹ represents H, OH, NH₂, substituted or non substituted O—C₁-C₃-alkyl, substituted or non substituted O—C₁-C₆-alkyl, substituted or non substituted C₁-C₆-alkyl, N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃; and
R² represents H, methyl, ethyl, propyl, cyclopropyl, isopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, monohalo, polyhalo, perhaloalkyl, substituted or non substituted C₂-C₆-alkenyl, substituted or non substituted C₂-C₆-alkynyl; and
R³, R⁴, R⁵, R⁶, and R⁷ are independently selected from H, methyl, ethyl, propyl, isopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; or R⁶ and R⁷ of Formula III are linked together to form a (CH₂)₃, (CH₂)₄, (CH₂)₅, or (CH₂)₆ ring structure, R⁶ and R⁷ of Formula IV are linked together to form a (CH₂)₃, (CH₂)₄, (CH₂)₅, or (CH₂)₆ ring structure, or R⁴ and R⁵ of Formula V are linked together to form a (CH₂)₃, (CH₂)₄, (CH₂)₅, or (CH₂)₆ ring structure; and/or

optically active and/or geometric isomers and/or salts thereof.

In a further aspect, a compound of Formula III, IV, or V is as follows:
R¹ represents H, OH, NH₂;
R² represents methyl, ethyl, propyl, isopropyl, cyclopropyl, butyl, tert-butyl, trifluoromethyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl;
R³, R⁴, R⁵, R⁶, or R⁷ are independently selected from H, methyl, ethyl, propyl, isopropyl, butyl, tert-butyl, or a halogen; and/or

optically active and/or geometric isomers and/or salts thereof.

In a further aspect, a compound of Formula III, IV, or V is as follows:
R¹ represents H, OH, NH₂;
R² represents methyl, ethyl, propyl, isopropyl, cyclopropyl, butyl, tert-butyl, or trifluoromethyl;
R³, R⁴, R⁵, R⁶, or R⁷ are independently selected from H, methyl, ethyl, propyl, isopropyl, butyl, tert-butyl, or a halogen; and/or

optically active and/or geometric isomers and/or salts thereof.

In a further aspect, a compound of Formula III, IV, or V is as follows:
R¹ represents H, OH, NH₂;
R² represents methyl or ethyl;
R³, R⁴, R⁵, R⁶ are H; and
R⁷ is methyl, ethyl, propyl, isopropyl, or cyclopropyl; and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula VI, VII, VIII, or IX:

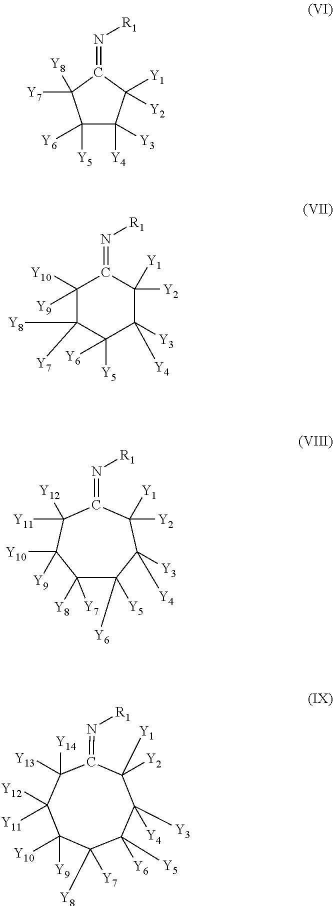

in which,
R¹ represents H, OH, NH₂, substituted or non substituted O—C₁-C₃-alkyl, substituted or non substituted O—C₁-C₆-alkyl, substituted or non substituted C₁-C₆-alkyl; N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃; and
Y¹, Y², Y³, Y⁴, Y⁵, Y⁶, Y⁷, Y⁸, Y⁹, Y¹⁰, Y¹¹, Y¹², Y¹³, and Y¹⁴ are independently selected from H, OH, methyl, ethyl, propyl, isopropyl, cyclopropyl, butyl, or tert-butyl, a halogen, trifluoromethyl, or C₁-C₃-alkyl, or one or more of Y¹, Y², Y³, Y⁴, Y⁵, Y⁶, Y⁷, Y⁸, Y⁹, Y¹⁰, Y¹¹, Y¹², Y¹³ and Y¹⁴ is absent and a double bond is present, and/or

optically active and/or geometric isomers and/or salts thereof.

In a further aspect, a compound of Formula VI, VII, VIII, or IX is as follows:
Y¹, Y², Y³, Y⁴, Y⁵, Y⁶, Y⁷, Y⁸, Y⁹, Y¹⁰, Y¹¹, Y¹², Y¹³, and Y¹⁴ are independently selected from H, methyl, a halogen, and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula X:

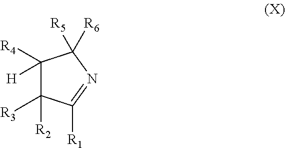

in which
R¹ represents H, OH, NH₂, methyl, ethyl, propyl, cyclopropyl, isopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, a substituted or non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, substituted or non substituted C₂-C₆-alkenyl, substituted or non substituted C₂-C₆-alkynyl; and
R², R³, R⁴, R⁵, and R⁶ are independently selected from H, OH, methyl, ethyl, propyl, cyclopropyl, isopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or

optically active and/or geometric isomers and/or salts thereof.

In a further aspect, a compound of Formula X is as follows:
R¹ represents H, OH, NH₂, methyl, or ethyl,
R², R³, R⁴, R⁵, and R⁶ are independently selected from H, methyl, ethyl, or a substituted or non substituted C₂-C₆-alkyl propyl; and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula XI:

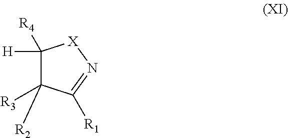

in which
X represents S, C═O, S, S(O), SO₂, or NR′, wherein R′ is H, methyl, ethyl, propyl, cyclopropyl, isopropyl, butyl, tert-butyl, pentyl, a substituted or non substituted C₂-C₆-alkyl, or a substituted or non-substituted C₂-C₁₂-alkyl;
R¹ represents H, OH, NH₂, methyl, ethyl, propyl, cyclopropyl, isopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, substituted or non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, substituted or non substituted C₂-C₆-alkenyl, substituted or non substituted C₂-C₆-alkynyl; and
R², R³, and R⁴ are independently selected from H, methyl, ethyl, propyl, isopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or

optically active and/or geometric isomers and/or salts thereof.

In a further aspect, a compound of Formula XI is as follows:
X represents S, C═O, S, S(O), SO₂, or NR′, wherein R′ is H, methyl, ethyl, or substituted or non substituted C₂-C₆-alkyl,
R¹ represents H, OH, NH₂, methyl, or ethyl,
R², R³, and R⁴ are independently selected from H, methyl, ethyl, or a substituted or non substituted C₂-C₆-alkyl propyl; and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula XII:

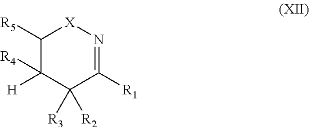

in which
X represents S, C═O, S, S(O), SO₂, or NR′, wherein R′ is H, methyl, ethyl, propyl, cyclopropyl, isopropyl, butyl, tert-butyl, pentyl, a substituted or non substituted C₂-C₆-alkyl, or a substituted or non-substituted C₂-C₁₂-alkyl;
R¹ represents H, OH, NH₂, methyl, ethyl, propyl, cyclopropyl, isopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, a substituted or non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, substituted or non substituted C₂-C₆-alkenyl, substituted or non substituted C₂-C₆-alkynyl; and
R², R³, R⁴, and R⁵ are independently selected from H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or

optically active and/or geometric isomers and/or salts thereof.

In a further aspect, a compound of Formula XII is as follows:
X represents S, C═O, S, S(O), SO₂, or NR′, wherein R′ is H, methyl, ethyl, or substituted or non substituted C₂-C₆-alkyl,
R¹ represents H, OH, NH₂, methyl, or ethyl,
R², R³, R⁴, and R⁵ are independently selected from H, methyl, ethyl, or a substituted or non substituted C₂-C₆-alkyl propyl; and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula XIII:

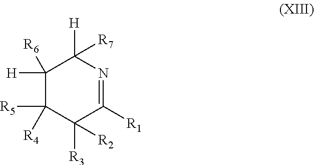

in which
R¹ represents H, methyl, ethyl, propyl, cyclopropyl, isopropyl, butyl, tert-butyl, pentyl, hexyl, heptyl, octyl, nonyl, decyl, substituted or non substituted C₂-C₆-alkyl, substituted or non-substituted substituted C₂-C₁₂-alkyl, non substituted C₂-C₆-alkenyl, a substituted or non substituted C₂-C₆-alkynyl, substituted or non substituted C₃-C₆-cycloalkyl, allyl, O-allyl, C₁-C₆-halogenalkyl, a halogen, trifluoromethyl, substituted or non substituted C₂-C₆-alkenyl, substituted or non substituted C₂-C₆-alkynyl; and
R², R³, R⁴, R⁵, R⁶, and R⁷ are independently selected from H, methyl, ethyl, propyl, isopropyl, cyclopropyl, butyl, tert-butyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or

optically active and/or geometric isomers and/or salts thereof.

In a further aspect, a compound of Formula X is as follows:
R¹ represents H, OH, NH₂, methyl, or ethyl,
R², R³, R⁴, R⁵, R⁶, and R⁷ are independently selected from H, methyl, ethyl, or a substituted or non substituted C₂-C₆-alkyl propyl; and/or

optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula XIV:

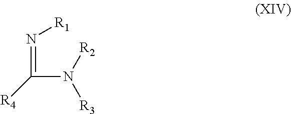

in which
R¹ represents H, NH₂, OH, methyl, ethyl, propyl, isopropyl, cyclopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl, OH, NH₂, substituted or non substituted O—C₁-C₃-alkyl, substituted or non substituted O—C₁-C₆-alkyl, N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃; and
R², R³, and R⁴ are independently selected from H, NH₂, OH, methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or
   optically active and/or geometric isomers and/or salts and/or conjugated forms thereof.

In a further aspect, a compound of Formula XIV is as follows:
R¹ represents H, methyl, ethyl, propyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl; and
R², R³, and R⁴ are independently selected represents H, methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl; and/or
   optically active and/or geometric isomers and/or salts thereof.

In a further aspect, a compound of Formula XIV is as follows:
R¹ represents H, methyl, ethyl, propyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl; and
R² represents methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl;
R³ represents H;
R⁴ represents methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl; and/or
   optically active and/or geometric isomers and/or salts thereof.

In a further aspect, a compound of Formula XIV is as follows:
R¹ represents H, methyl, or ethyl;
R² represents methyl, or ethyl,
R³ represents H;
R⁴ represents methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl; and/or
   optically active and/or geometric isomers and/or salts thereof.

In a further aspect, a compound of Formula XIV is as follows:
R¹ represents H, methyl, or ethyl;
R² represents methyl,
R³ represents H;
R⁴ represents methyl, ethyl, propyl, cyclopropyl, isopropyl, butyl, tert-butyl, pentyl, or a substituted or non substituted C₂-C₆-alkyl; and/or
   optically active and/or geometric isomers and/or salts thereof.

In another aspect, the disclosure provides for a compound, composition, device, kit, as well a method of attracting, arresting, aggregating, detecting, eradicating, controlling, or killing an insect by utilizing a compound of Formula XV:

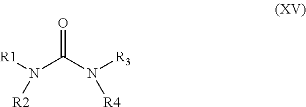

in which
R¹, R², R³, and R⁴ are independently selected from H, NH₂, OH, methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or
   optically active and/or geometric isomers and/or salts thereof.

In a further aspect, a compound of Formula XV is as follows:

in which
R¹, R², R³, and R⁴ are independently selected from H, NH₂, OH, methyl, ethyl, propyl, cyclopropyl, isopropyl, butyl, tert-butyl, pentyl, tert-butyl, pentyl, hexyl, heptyl, octyl, nonyl, decyl; and/or
   optically active and/or geometric isomers and/or salts thereof.

In a further aspect, a compound of Formula XV is as follows:

in which
R¹ and R³ are NH₂; and
R² and R⁴ are independently selected from H, NH₂, OH, methyl, ethyl, propyl, cyclopropyl, isopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₆-alkyl, substituted or non substituted C₃-C₆-cycloalkyl, substituted or non substituted C₂-C₆-alkenyl, substituted or non substituted C₂-C₆-alkynyl, a halogen, substituted or non substituted O—C₁-C₃-alkyl; and/or
   optically active and/or geometric isomers and/or salts thereof.

In a further aspect, a compound of Formula XV is as follows:

in which
R¹ and R³ are NH₂; and
R² and R⁴ are independently selected from H or substituted or non substituted C₂-C₆-alkyl; and/or
   optically active and/or geometric isomers and/or salts thereof.

In a further aspect, a compound of Formula XV is as follows:

in which
R¹ and R³ are independently selected from OH and NH₂; and
R² and R⁴ are independently selected from methyl, ethyl, propyl, cyclopropyl, isopropyl, butyl, tert-butyl, pentyl, tert-butyl, pentyl, hexyl, heptyl, octyl, nonyl, decyl; and/or
   optically active and/or geometric isomers and/or salts thereof.

In a further aspect, a compound of Formula XV is as follows:

in which
R¹ and R³ are NH₂; and
R² and R⁴ are H; and/or
   optically active and/or geometric isomers and/or salts thereof.

In an aspect, a halogen is selected from the group consisting of F, Cl, BR, and I. In yet a further aspect, C₁-C₃-alkyl includes methyl, ethyl, propyl, or isopropyl, C₁-C₆-alkyl includes methyl, ethyl, propyl, isopropyl, butyl, tert-butyl, pentyl, or hexyl, and C₃-C₆-cycloalkyl includes substituted and nonsubstituted cyclopropyl, cyclobutyl, cyclopentyl, and cyclohexyl.

In an aspect, the disclosure provides for an E (anti) or Z (syn) geometric isomer of a compound described herein. In another aspect, the disclosure provides for an E (anti) or Z (syn) geometric isomer of a compound of Formula I-XV or an E (anti) or Z (syn) geometric isomer of a compound selected from one or more of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide.

In another aspect, the disclosure provides for an insect attractant, arresting, and/or aggregating compound, composition, device, support material, kit, as well a method of attracting, arresting, aggregating, detecting, eradicating, controlling, or killing an insect by utilizing a composition comprising a compound selected from the group consisting of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide.

In an aspect, the disclosure provides for a detection device for monitoring or detecting bed bug infestation, comprising
a first plate and a second plate, wherein the first plate and the second plate are separated by an internal spacing sized to permit entry into the detection device by a bed bug; and
a composition comprising a compound as described herein.

In an aspect, the disclosure also provides for a method of luring or arresting an insect into an area treated with a compound or composition described herein. In an aspect, an insect, such as a bed bug, is arrested in a given area for about 10 minutes, about 30 minutes, about 1 hour, about 8 hours, about 24 hours, about 2 days, about 7 days, about 2 weeks, or about 1 month. In one aspect, a support material is present in the treated area. In another aspect, an insect, such as a bed bug, is arrested in a given area for from about 1 hour to about 8 hours, from about 12 hour to about 2 days, or from about 1 day to about 7 days.

In one aspect, a support material is present in the treated area. In another aspect, the support material is capable of being coated, impregnated, or sprayed with a compound described herein. Without being limited, the support material can be an absorbent material, wood, cardboard, corrugated cardboard, cotton, wallpaper, paper, plastic, a plastic tube, or metal. In an aspect, the treated area can be, for example, a bed, a pillow, a pillow case, a mattress, a box spring, a bed frame, a headboard, a sheet, a carpet, furniture, a picture frame, a book case, an upholstered chair, a sofa and wood furniture, along and beneath a baseboard, a floor area, under a bed or under a couch or any place a bed bug is prone to rest or hide.

In accordance with a further aspect, there is provided a method for monitoring the presence or absence of insects, such as bed bugs, in multiple discreet areas such as in hotel rooms, bedrooms, animal holding areas such as chicken houses, barn stalls, etc. In accordance with this method, a device which allows for the entry of an insect such as bed bug may be placed in each location sought to be monitored. There can be one device or hundreds or more devices depending on how many discreet areas need to be monitored separately. For example, in a hotel, a separate device could be mounted to each bed in each room in the hotel. The device can be any desired device, for example, the device as disclosed herein. In an aspect, the device or devices can be checked on a periodic basis, for example, weekly, biweekly, every 24 hours, or as desired, and if the device has evidence of insect contact such as by viewing the insect in the device, by noticing feces in the device and/or by presence of blood from insect feces, then the area where that particular device was mounted is then subjected to a treatment regime to eliminate or reduce the activity of the insect in that area.

In another aspect, the disclosure provides a method of treating, controlling, monitoring, or detecting bed bug infestation comprising adding a compound, composition, or bait material described herein to a support material, detection device, or trap and placing the support material, device, or trap in an area prone to bed bug infestation. In another aspect, the support material, detection device, or trap is placed in an area after identification of bed bug infestation. In yet another aspect, the support material, detection device, or trap is placed in an area prior to identification of bed bug infestation. In another aspect, the disclosure provides a method of killing or eradicating bed bugs comprising adding a compound or composition described herein to a support material, detection device, or trap and placing the support material, device, or trap in an area prone to bed bug infestation.

In an aspect, the area prone to bed bug infestation includes, for example, a bed, a pillow, a pillow case, a mattress, a box spring, a bed frame, a headboard, a sheet, a carpet, furniture, a picture frame, a book case, an upholstered chair, a sofa and wood furniture, along and beneath a baseboard, a floor area, under a bed and a couch or any place a bed bug is prone to rest or hide. In another aspect, from about 1 to about 6, from about 2 to about 4, or from about 1, 2, 3, 4, 5, 6, 7, 8, 9, or 10 or more detection devices, traps, or support materials are placed in an area prone to bed bug infestation. In yet another aspect, the device, trap, or support material is evaluated by an individual or PMP for bed bug infestation from about 1 to about 5 times, about 1 to about 3 times, or from about 2 to about 4 times a day, from about 1 to about 10 times, from about 3 to about 8 times, or from about 1 to about 5 times a week, or from about 1 to about 30 times, from about 5 to about 20 times, from about 1 to about 5 times a month.

In an aspect according to the disclosure, the insect is a bed bug. In another aspect, the bed bug is from the species Cimex lectularius, Cimex hemipterus, Leptocimex boueti, Cimex pilosellus, Cimex pipistrella, or Haematosiphon inodora. In yet another aspect, the bed bug is from Cimex sp. or other genera in the Cimicidae family, for example the genus Haematosiphon, or the genus Oeciacus. In a further aspect, the bed bug is a first, second, third, fourth, or fifth instar. In another aspect, the bed bug is a fourth or fifth instar bed bug. In a further aspect, the bed bug is a large nymph bed bug.

In an aspect, the methods, compositions, and devices may be practiced with additional insects, such as Blood-feeding Reduvidae, for example a kissing bug, or other Heteroptera that aggregate during all or part of their life cycle. In another aspect, the methods, compositions, and devices may be practiced with additional insects, such as mosquitoes, lice, ticks, fleas, deer ticks, poultry lice or other arthropods such as tick species. In yet another aspect, the methods, compositions, and devices may be practiced with additional arthropods or blood feeding animals or insects. In an aspect, the behavior of the above groups may be altered by common, the same, structurally, or functionally similar chemical or biological compounds. In yet another aspect, the above groups are attracted, arrested, or aggregated by compounds, such as the ones described herein.

### Compositions:

The disclosure provides for bait compositions comprising a compound or composition described herein. In an aspect, the disclosure provides for a method of treating insect infestation by providing a bait material comprising a compound according to the disclosure. The bait composition may be used in any of the methods described herein.

Without being limited, specific compounds capable of being used in a bait composition include one or more, two or more, three or more, or four or more of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide.

The disclosure also provides for compositions comprising, consisting of, or consisting essentially of compounds described herein. In an aspect, the disclosure provides for a composition comprising a compound described herein together with one or more compounds selected from cholesterol, (E)-2-hexenal, (E)-2-hexenol, (E,E)-2,4-hexadienal, (E)-2-octenal, or 2-Heptanone.

The disclosure also provides for compositions comprising, consisting of, or consisting essentially of an insect attractant compound described herein together with an insecticide. Any insecticide could be used in connection with the present compositions and methods. Notably, for example, any insecticide capable of killing an insect, such as a bed bug, can be combined with insect attractant compounds described herein. Examples of insecticides which may optionally be admixed include: phosphoric esters, such as acephate, chlorpyrifos, dichlorovos, malathion or propetamphos; carbamates, such as bendiocarb, carbaryl, or propoxur; pyrethroids, such as allethrin, bifenthrin, bioallethrin, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, esfenvalerate, etofenprox, fenpropathrin, fenvalerate, flumethrin, tau-fluvalinate, halfenprox, imiprothrin, permethrin, phenothrin, prallethrin, pyrethrins (pyrethrum), resmethrin, silafluofen, tefluthrin, tetramethrin or transfluthrin; nitroimines and nitromethylenes, such as 1-[(6-chloro-3-pyridinyl)-methyl]-4,5-dihydro-N-nitro-1H-imidazol-2-amine (imidacloprid), N-[(6-chloro-3-pyridyl)methyl-]N.sup.2-cyano-N.sup.1-methylacetamide (NI-25); phenylpyrazoles, such as fipronil or ethiprole; avermectins, such as abamectin or emamectin benzoate; spinosyns, such as spinosad or spinetoram; oxadiazines, such as indoxacarb or metaflumizone; anthranilic diamides, such as flubendiamid, chlorantraniliprole or cyantraniliprole; sulfoximines, such as sulfoxaflor; insect growth regulators, such as methoprene, chlorfluazuron, flufenoxuron, pyriproxyfen, triflumuron or flufenoxuron; and other insecticidally active compounds, such as azadirachtin, chlorfenapyr, hydramethylnon, petroleum oils or botanical oils. Any of the above insecticide compositions can be used in conjunction with the insect attractant, arresting, and/or aggregation compounds and compositions described herein.

In addition, compositions of the present disclosure and methods for their use can include other actives and inactives as well known in the art

In another aspect, compounds described herein may be combined with other compounds present in bed bug extract. Moreover, additional compounds isolated from bed bugs can be combined with compounds described herein. Many such compounds are representative of aggregation, alarm, and/or sexual pheromones. In an aspect, other compounds or compositions capable of being combined with compounds described herein include those disclosed in “Identification of the Airborne Aggregation Pheromone of the Common Bed Bug, Cimex lectularius”, Journal of Chemical Ecology, vol 34, no. 6, June 2008, which is incorporated herein by reference in its entirety. Other suitable attractants or arrestants include food attractants in any form, such as in solid, gel or liquid form. It is also possible to utilize carbon dioxide, heat, methanol, methane, furan, pyridine, human perspiration, lactic acid, butyric acid, octenol, trans-2-octenal, trans-2-hexenal, 2-butanone, lactic acid, indole, 6-methyl-5-hepten-2-one, geranyl acetone, 1-dodecanol, 3-methyl-1-butanol, carboxylic acids, urea, and sebum (a component of skin oil). Suitable attractants or arrestants also can include one or more harboraging agents. Any of the above compounds or compositions attractants or arrestants may also be used in conjunction with compounds or compositions described herein.

Compounds and compositions of the disclosure may be present in any amount sufficient to attract, arrest, aggregate, control, an insect, such as a bed bug. In an aspect, the disclosure provides for a composition comprising from about 200 ng to about 10 mg of a compound described herein. In another aspect, a compound described herein can be present in an amount from about 500 ng to about 5 mg, from about 500 ng to about 2 mg, from about 500 ng to about 1 mg, from about 1000 ng to about 1 mg, from about 0.01 mg to about 5 mg, from about 0.01 mg to about 1 mg, from about 0.1 mg to about 5 mg, from about 0.1 mg to about 1 mg; from about 0.5 mg to about 2 mg, and from about 0.5 mg to about 1 mg. In another aspect, a compound described herein can be present in an amount from about 100 ng to about 5000 ng, from about 100 ng to about 1000 ng, and from about 100 ng to about 500 ng.

In an aspect, the disclosure provides for a composition comprising from about 1 μg to about 1000 μg of a compound described herein. In another aspect, a compound described herein can be present in an amount from about 1 μg to about 500 μg, from about 10 μg to about 300 μg, from about 10 μg to about 100 μg, or from about 20 μg to about 80 μg.

In another aspect, a compound described herein can be present from about 10 ng, about 50 ng, about 100 ng, about 200 ng, about 500 ng, about 1000 ng, about 5000 ng, about 0.01 mg, about 0.2 mg, about 0.5 mg, about 1 mg, about 2 mg, about 3 mg, about 5 mg about 10 mg, about 20 mg, or about 50 mg. In yet another aspect, a compound described herein can be present from about 10 ng or more, about 50 ng or more, about 100 ng or more, about 200 ng or more, about 500 ng or more, about 1000 ng or more, about 5000 ng or more, about 0.01 mg or more, about 0.2 mg or more, about 0.5 mg or more, about 1 mg or more, about 2 mg or more, about 3 mg or more, about 5 mg or more, about 10 mg or more, about 20 mg or more, or about 50 mg or more.

In another aspect, a composition of the disclosure can contain from about 0.1% to about 99.9% by weight of a compound according to the disclosure. In another aspect, a composition of the disclosure can contain from about 10% to about 90%, from about 20% to about 80%, from about 25% to about 75%, from about 30% to about 70%, or from about 40% to about 60% by weight of a compound according to the disclosure.

In yet another aspect, a composition of the disclosure can contain from about 10%, about 20%, about 30%, about 40%, about 50%, about 60%, about 70%, about 80%, or about 90% by weight of a compound or insecticide according to the disclosure. Compositions of the disclosure can also contain from about 10% or more, about 20% or more, about 30% or more, about 40% or more, about 50% or more, about 60% or more, about 70% or more, about 80% or more, or about 90% or more by weight of a compound or insecticide according to the disclosure by weight of a compound according to the disclosure.

Compositions according to the disclosure may also include additional components such as excipients, binders, and diluents. In an aspect, compositions according to the disclosure can include diatomaceous earth and/or silica gel, such as Dri-die, as described in Benoit et al. (Journal of Medical Entomology 46 (3):572-579. 2009), which is herein incorporated by reference in its entirety. Plastizers such as dioctyl adipate and bis-2-ethyl-hexyl adipate, can also be added to the compositions.

In another aspect, compounds or compositions as described herein may be dissolved in a solvent. Any solvent capable of dissolving a compound disclosed herein is encompassed by the disclosure. In an aspect, a compound or composition described herein is dissolved or dispersed in an alcohol, a halogenated carbon solvent, methanol, ethanol, methylene chloride, chloroform, or acetone.

In a non-limiting aspect, compositions according to the disclosure may be formulated and used in various forms, such as aerosol dispenser, bait (ready for use), bait concentrate, block bait, capsule suspension, cold fogging concentrate, dustable powder, emulsifiable concentrate, emulsion oil in water, emulsion water in oil, encapsulated granule, fine granule, grain bait, granular bait, granule, macrogranule, microgranule, oil dispersible powder, oil miscible flowable concentrate, oil miscible liquid, paste, plate bait, scrap bait, smoke candle, smoke cartridge, smoke generator, smoke pellet, smoke rodlet, smoke tablet, smoke tin, soluble concentrate, soluble powder, suspension concentrate, oil dispersable or suspension in oil, tracking powder, ultra low volume (ulv) liquid, ultra low volume (ulv) suspension, vapour releasing product, water dispersible granules or tablets, water dispersible powder for slurry treatment, water soluble granules or tablets, or water soluble powder for seed treatment and wettable powder or any other forms of slow release/controlled release formulations.

### Compounds:

In an aspect, the disclosure provides for a support material combined with a compound or composition described herein. In another aspect, the support material can be coated or impregnated with an insect attractant compound or composition described herein. An insecticide can also be added to the support material coated or impregnated with a compound or composition described herein. In an aspect, the support material, device, composition, or method does not include an insecticide. Examples of support materials capable of being used with compounds described herein include an absorbent material, wood, cardboard, corrugated cardboard, cotton, wallpaper, paper, plastic, a plastic tube, and metal. Support materials with a low heat transfer rate may also be suitable.

In another aspect, the support material combined with a compound or composition described herein can be used to monitor, attract, aggregate, or arrest insects, such as bed bugs. In one aspect, the support material is combined with both a compound described herein and an insecticide. Such a support material can be used in a method of eradicating or killing insects. The support material can also be used in conjunction with a device, such as an insect trap or insect detection device or monitor. Without being limited, the detection devices described herein can be used with the support material. In another aspect, the insect trap, detection device, or monitor is specific for bed bugs.

In another aspect, one or more, two or more, three or more, or four or more compounds described herein can be used together in a composition, device, method, or kit described herein. In yet another aspect, one or more, two or more, three or more, or four or more of the compounds as set forth in Table I or Formula I-XV can be used together in a composition, device, method, or kit described herein.

In another aspect, the compounds of Table I are capable of attracting, arresting, aggregating, controlling, or altering behavior of an insect, such as a bed bug.

TABLE I

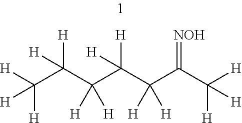

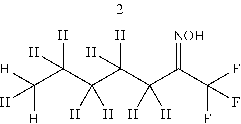

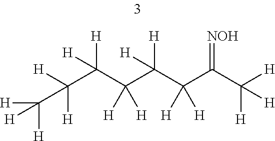

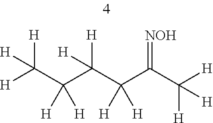

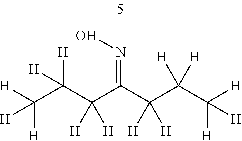

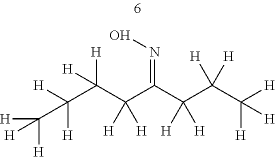

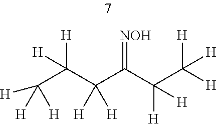

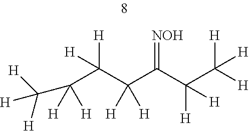

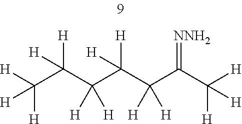

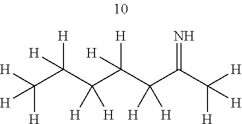

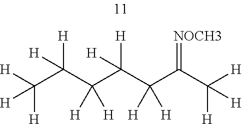

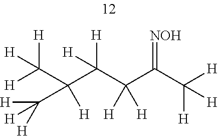

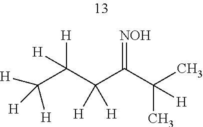

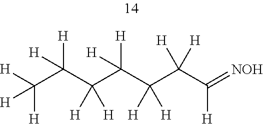

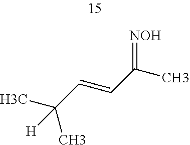

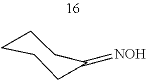

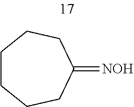

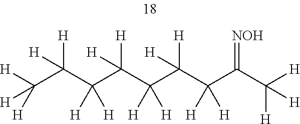

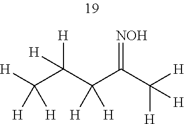

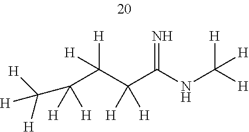

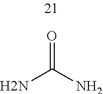

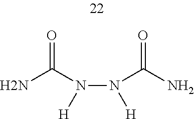

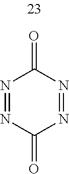

### Detection Device:

In another aspect, the disclosure provides for a detection device including a compound or composition as described herein.

A method for detecting the presence or absence of a bed bug using devices and compounds described herein is also provided. The method allows for the detection of bed bugs even when there are no bed bugs visible at the time of evaluation of the detection. This method takes advantage of the fact that bed bugs' feed on blood and those remainders of the blood such as heme, globin, or hemeoglobin can be detected in the bugs' feces. Another aspect of this method comprises applying a fecal occult blood test to insect feces to detect the presence of blood, which is a strong indication of bed bugs as the source of the feces. Generally, any test system can be used, for example, a detection system which allows for a visual readout, e.g., a color reaction.

In order to be able to easily apply this test to bed bug feces, it is useful to combine this method with the devices of the present disclosure which may be entered by bed bugs, and/or used by bed bugs for resting, and thus serve as a location for releasing feces. The feces can then be easily checked for the presence of blood with the above method.

In an aspect, a method for detecting the presence or absence of a bed bug is also provided, comprising: providing a detection device containing a compound or composition described herein, and wherein the detection device contains an internal volume and an opening sized to permit entry into the detection device by one or more bed bugs; and detecting the presence or absence of the bed bugs with a fecal occult blood test performed either in the device or on content of the device after removal of the same from the device.

In yet another aspect, the device described above may be prepared in such a way that a test for the presence of fecal blood can easily be performed and evaluated. To achieve this, in an aspect, the detection device contains an absorbent layer impregnated with a fecal blood detection agent, for example, a paper layer impregnated with a fecal blood detection agent. In an aspect, the absorbent layer impregnated with fecal blood is attached to a first plate. One example of a fecal blood detection agent is a guaiac-resin, which is capable of displaying a visible indicia in presence of fecal blood from the bed bug when hydrogen peroxide as developing agent is added. In another aspect, in order to allow a read-out within the device, a plate of the device is transparent.

An example of a suitable detection device for use with compounds and compositions of the disclosure may be found in U.S. patent application Ser. No. 12/392,417, the contents of which are herein incorporated by reference in their entirety. Moreover, in an aspect, a detection device for monitoring bed bug infestation is provided, comprising: a first plate and a second plate, wherein the first plate and the second plate are separated by an internal spacing sized to permit entry into the detection device by a bed bug; a support structure between the first plate and the second plate; and a compound or composition as described herein. In an aspect, a compound or composition described herein is present on or in an absorbent layer. In another aspect, the absorbent layer is fixed to the first plate. The support structure between the first and second plate can be positioned in any desired manner and for any desired purpose such as for maintaining the internal spacing and/or to provoke thigmotactic behavior of the bed bugs.

In another aspect, the compound capable of being used with the detection device is a compound of Formula I-XV. In another aspect, the compound is selected from one or more of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide.

Bed bugs are attracted to materials with a rough surface texture and surface porosity. Examples of materials that may be used to form the detection device itself and/or be incorporated into the detection device include wood, cardboard, corrugated cardboard, cotton, or wallpaper. Materials with a low heat transfer rate may also be suitable in some cases.

In an aspect, if insects such as bed bugs are detected in one of the areas being monitored, bed linens and clothing can be first removed from the area. Beds can than be disassembled and bed bug-infested mattresses, box springs, couches or other belongings can be discarded. The area can than be treated with compounds and compositions according to the disclosure in conjunction with any insecticide known to be active against the insect that has infested the area.

In an aspect, after treatment, additional follow-up inspections can be made, for example, on a biweekly basis. Since bed bugs are often hard to eradicate, to achieve the desired outcome, thorough inspections and repeated applications should be made and a sufficient quantity of insecticide should be used. In an aspect, the amount of time spent in each infested area on the initial treatment can range from 1 to 2 hours, with each follow-up service or treatment lasting at least an additional hour or more. Once an area has been treated, a new device can be installed in that area for future monitoring of the presence or absence of insects.

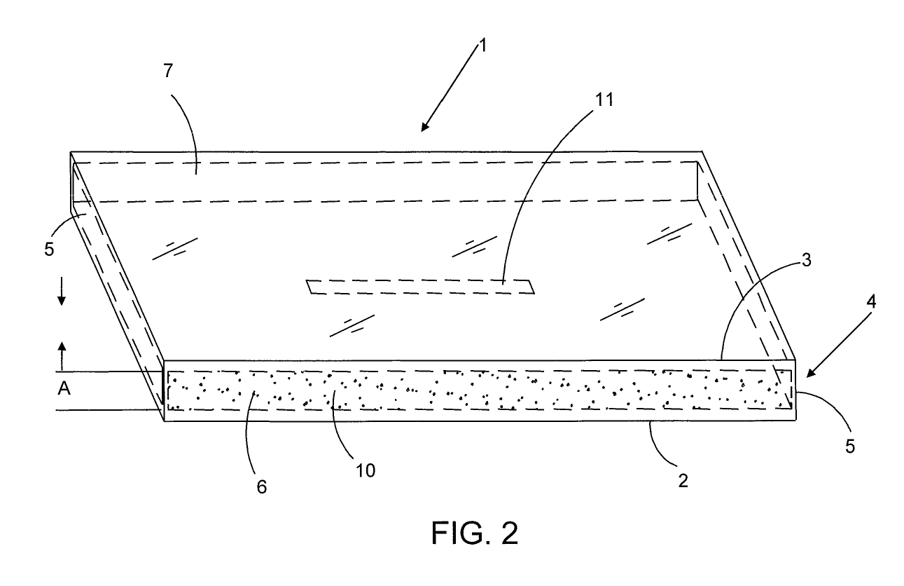

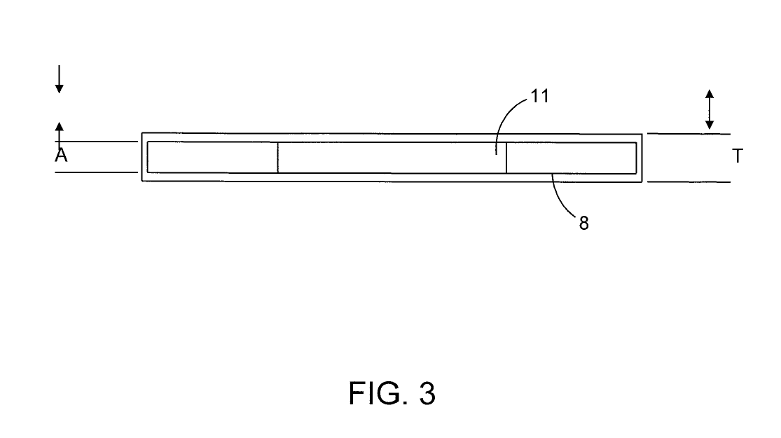

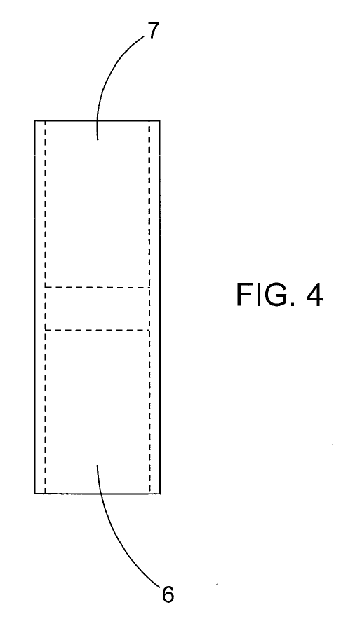

FIG. 2 describes a detection device 1 for monitoring bed bug infestation according to one embodiment. As shown in FIG. 2, the detection device 1 includes a first plate 2 and a second plate 3. The first plate 2 is a surface over which the bed bugs are expected to traverse. The first plate 2 and the second plate 3 are separated by an internal spacing A, sized to permit entry into the detection device 1 by one or more bed bugs (not shown). A support structure 4 exists between the first plate 2 and the second plate 3 for maintaining the internal spacing A. Such support structure 4 can simply be side walls 5 at opposing ends of the device 1, such that entry slots 6, 7 are defined. In an aspect, the compound or composition described herein can be used with the detection device of FIG. 2, FIG. 3, or FIG. 4.

In an aspect, the internal spacing A is designed to be sufficiently large to permit bed bugs to enter the detection device 1, but still small enough to appeal to the tendencies of bed bugs to inhabit small cracks and crevices. For example, the internal spacing A may be between about 1 mm and about 15 mm, or between about 2 mm and about 13 mm, or between about 5 mm and about 11 mm, or between about 7 mm and about 9 mm. In an aspect, the internal spacing A may be about 1 2, 3, 4, 5, 6, 7, 8, 9, or 10 mm.

In another aspect, a small stick 11 is affixed between the first plate 2 and the second plate 3. Small stick 11 is intended to provoke thigmotactic behavior of the bed bug. Thigmotaxis is the change in direction of locomotion of an insect made in response to a tactile stimulus, such as by touching the stick 11. It is believed that by touching the stick 11, the stimulus may inhibit movement, causing the bed bug to remain in close contact with the interior of the device 1.

In one aspect, the stick 11 is positioned parallel to the length edge of the detection device 1. In this embodiment, the stick 11 is positioned between about 2 mm and about 20 mm, or between about 5 mm and about 17, or about 12 mm from one length edge of the detection device 1.

In another aspect, the detection device may have multiple sticks 11, each of which may be positioned independently of each other to maximize detection of bed bugs. In another embodiment, the stick 11 is not straight. Stick 11 may be curved, zig-zagged, wavy, or any combination thereof.

The detection device 1 may be constructed in a wide range of sizes. Suitable ranges of width W of the detection device 1 include between about 5 mm and about 50 mm, or between about 10 mm and 40 mm, or between about 15 mm and about 35 mm, or about 25 mm. Suitable ranges of length L of the detection device 1 include between about 25 mm and about 125, or between about 50 mm and about 100 mm, or about 75 mm. Suitable ranges of thickness T of the detection device 1 include between about 1 mm and about 15 mm, or between 3 mm and about 12 mm, or between about 5 mm to about 10 mm in thickness T. Factors in determining the overall size of the detection device 1 are portability and discretion, such that the detection devices 1 can easily be placed in areas not readily visible by human occupants. The detection device 1 may be of any shape, including square, rectangular, triangular, and round. A round detection device 1 may have a radius R from about 10 mm to about 50 mm.

In an aspect, the first plate 2 and the second plate 3 are constructed from a polycarbonate material. Any desired polycarbonate material can be utilized such as MAKROLON, a product marketed by Bayer MaterialScience AG, TRISTAR, a product marketed by PTS LLC, as well as any other desired material. Polycarbonate is but one option and the plates can be formed of any desired product as useful in a particular situation. In another embodiment, the first plate 2 or the second plate 3, or both, is at least partially transparent so that visual inspection of the inner surfaces of the detection device 1 may be conducted. In this manner, a user or PMP may visually detect the presence or absence of a bed bug or whether a fecal blood detection agent indicates a reaction to fecal blood from the bed bugs.

In another aspect, the first plate 2 includes a textured surface 10, which can be achieved by the use of the absorbant layer 8 previously described. Such a textured surface 10 enables the bed bugs to cling to the inside of the device 1, so that when the device 1 is removed for inspection, the bed bugs are not inadvertently dislodged.

Within the detection device 1, a fecal blood detection agent may be applied to the first plate 2. One example of a fecal blood detection agent is a guaiac-resin solution, which it is capable of displaying a visible indicia in the presence of fecal blood from the bed bug. An example of fecal a blood detection agent includes HEMOCCULT, HEMOCCULT II, HEMO-FEC, GAMMA FE-CULT, FECATEST, and CAMCO-PAC GUAIAC. After application of a developing solution (which generally comprises hydrogen peroxide) to fecal points, such fecal blood detection agents display a color change of a material in the presence of fecal blood from the bed bugs. In another aspect, the first plate 2 includes a paper layer 8 impregnated with the fecal blood detection agent.

In an aspect, the detection device can include a compound or composition as described herein applied to the inner surfaces of the detection device 1, such as to the paper layer 8. Detection devices 1 may be refreshed with additional attractants from time to time as their effectiveness may become attenuated after repeated use of the detection device 1.

In another aspect, the detection device 1 can include an insect attractant compound or composition as described herein together with an insecticide applied to an inner surface of the detection device 1. Without being limited, the insecticide may be selected from the group consisting of carbamates, pyrethroids, phenylpyrazoles, such as fipronil or ethiprole, chloronicotinyles, imidacloprid, acetamiprid, thiacloprid, nitenpyram, clothianidin, and pynaxpyr.

In another aspect, the disclosure provides for a method for operation of the detection device 1. In this method, the detection device 1 is placed into areas where it is believed that bed bugs may be present, such as under mattresses, between sheets, or similar areas. Retrieval and inspection of the detection device 1 can be accomplished on a daily basis by non-technical personnel or by PMPs as needed. If the presence of bed bugs is detected in a particular detection device 1, that detection device 1 may be disposed to prevent further infestation.

Detection device 1 may be constructed of degradable components including degradable paper and one or more degradable plastics. In addition, the detection device 1 may contain degradable chemicals, such as degradable attractants, degradable insecticides, and degradable detection agents.

The detection devices described herein present a cost-effective solution to bed bug detection and monitoring. About three to six detection devices 1 may be placed in a typical hotel room. In an aspect, the detection device 1 would have a serviceable life of about 3 months to about 12 months before disposal. Hotel workers and other PMPs may place the detection device 1 in locations that permit easy retrieval, but that are not readily discernable by room occupants.

The detection device 1 may be attached by adhesive means or by conventional hook and loop fastening materials to bed structures or similar surfaces. In another embodiment, the detection device 1 comprises a magnetic strip.

The detection device 1 may be manufactured individually or as a block of detection devices 1. If manufactured as a block, the individual detection devices may be separated subsequently prior to packaging. The detection devices 1 may be sealed in individual packages or in a package with a several detection devices 1.

The detection device 1 may be manufactured as single-use or multiple-use. In addition, the detection devices 1 may be customized to include items such as a company's logo, a label that lists the room number, the date that the detection device 1 was opened or installed, the name of the hotel or motel where the detection device 1 is being used, etc. In another embodiment, the label listing the room number may be removable so that it can be catalogued or used in a reporting program.

Use of a detection devices 1 allows PMPs to realize labor savings in following up treated properties with less time than present inspection techniques. Furthermore, such PMPs can offer an added service to assure business owners that everything possible is being done to control the infestation. Similarly, hospitality industry businesses can point to such bed bug surveillance and prevention programs in defense of legal action by guests that have been affected.

### Kit:

Also provided is a kit comprising, consisting of, or consisting essentially of a composition comprising a compound as disclosed herein. In one aspect, the kit comprises a compound from Formula I-XV or at least one of the following compounds: the compound is selected from one or more of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, or 1,2-Hydrazindicarboxamide.

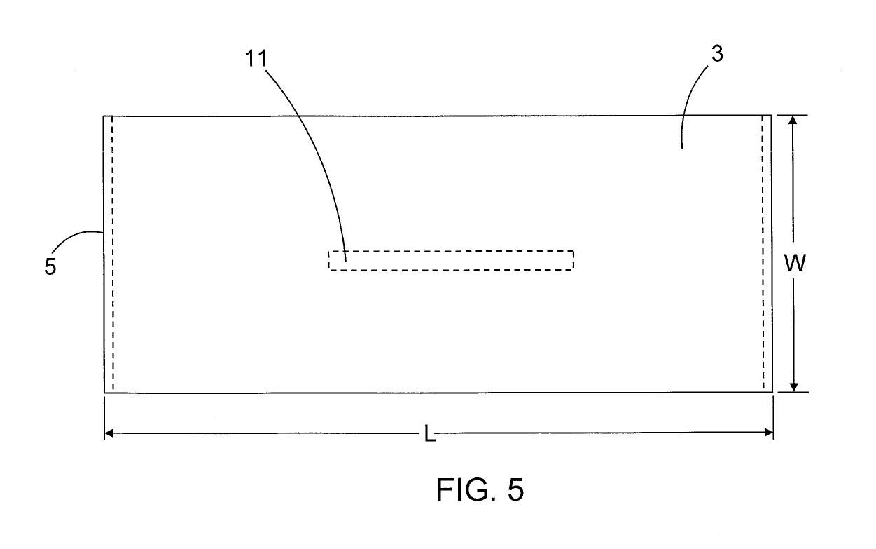

The kit may also include instructions for describing procedures associated with the disclosed methods. In yet another aspect, the kit comprises instructions for using a compound or composition as described herein for attracting, arresting, aggregating, detecting, controlling, eradicating, or killing an insect. In an aspect, the kit is configured to treat, detect, or control bed bug infestation. In an aspect, the detection device is one described herein. In another aspect, the detection device contains at least one structural element as set forth in FIGS. 2-5.

In another aspect, the kit comprises an insect detection device, support material, bait, or trap as described herein together with a compound or composition as described herein. The kit may also include an insecticide or other composition component as described herein. In yet another aspect, the kit does not include an insecticide.

In another aspect, the kit can contain a single-use disposable detection device, bait, support material, or trap. The kit may also contain a reusable multi-use detection device, bait, support material, or trap.

In another aspect, the kit may include a supplement to the detection device, bait, support material, or trap. For example, the supplemental kit may contain an additional bait composition or other supplement to the to the detection device, bait, support material, or trap. In one aspect, the supplemental kit is packaged separate from the detection device, bait, support material, or trap. In another aspect, the supplemental kit is packaged together with the detection device, bait, support material, or trap.

### EXAMPLES

### Example 1

In this Example, bed bugs were tested in two-choice bioassay tests using the following procedure:

Individual behavioral responses to test solutions were carried out in 500-ml glass beakers. The bottom-inside surfaces of the 500-ml glass beakers were covered with a white filter paper (70 mm diameter; Fisherbrand, quality P4). The paper was fixed to the glass with double-sided tape. After each assay, papers were changed and beakers were rinsed with acetone. The choice for the bed bugs in the assay consisted of tents made of filter paper (15×12 mm, Whatman no. 2) folded in the middle to offer a tent-like shelter of 15 mm×6 mm with two open ends. The assays lasted about 16 hours (from about 4:30 p.m. to 8:30 a.m of the next day) with the following light-dark regimen: lights off at 9 p.m. and lights on at 7 a.m. (the same light cycle used during rearing). The room temperature remained at 24±2° C. Prior to the releases, insects were acclimated to the environment for 15 min in a shell vial (21 diam.×70 mm height) which was placed inverted in the center of the arena. At the end of the test, the location of the insects resting in a tent or wandering in the arena (considered as “out”) was recorded. The number of responses was further analyzed by a binomial test with exact two-tailed P values, with the null hypothesis that the tent were chosen with equal probability.

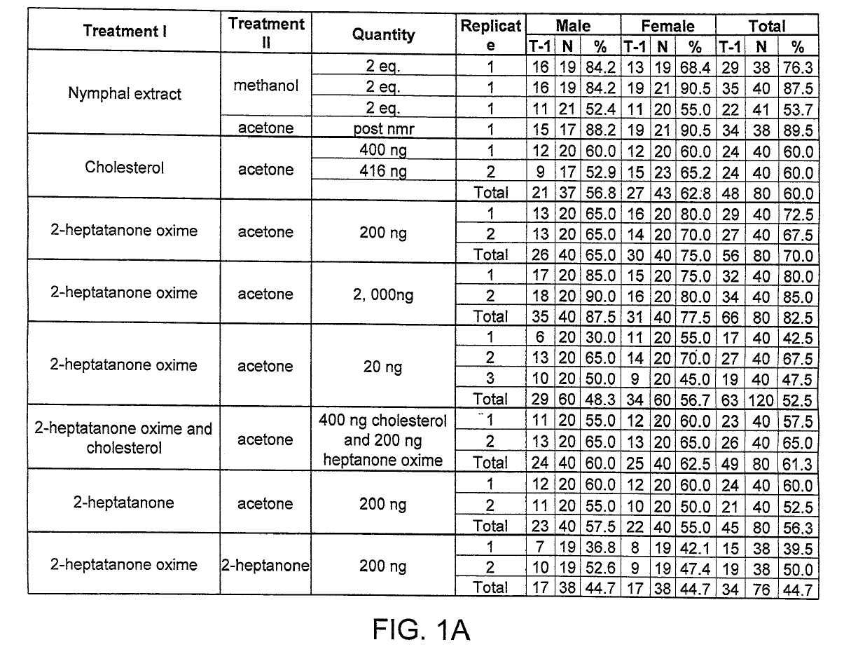

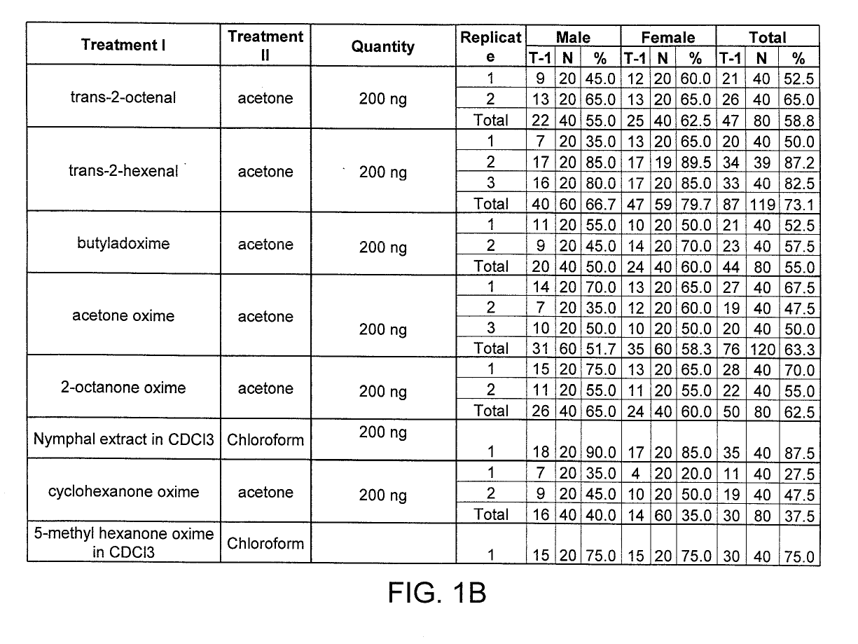

FIG. 1 represents an example of a two-choice test with bed bugs from the species Cimex lectularius. As set forth in FIG. 1, the relative attraction of bed bugs was analyzed.

### Example 2

The attraction, arresting, or aggregation of bed bugs from the species Cimex lectularius to cholesterol, 2-Heptanone, and 2-Heptanone oxime was evaluated in Tables 2 and 3 by the following methodology.

In this example, 20 Cimex lectularius (adults) were placed in plastic boxes (20×20 cm). The bottom of each box was covered with paper. A piece of folded filter paper served as a shelter for the Cimex lectularius bed bugs. The bed bugs were fed two days before they were put into the test-arenas.

As set forth in Table 2, three types of devices were compared:

Device (A): a device containing cholesterol (Box 1), a device containing 2-Heptanone (Box 2), a device containing 2-Heptanone-oxime (Box 3), and a device containing 2-Heptanone and 2-Heptanone-oxime (Box 4);

Device (B): a device containing a mixture of cholesterol, 2-Heptanone, and 2-Heptanone-oxime (Box 1-4); and

Device (C) a device without an attractant, arresting, or aggregating compound, serving as a control (“UTC”).

The concentrations of the compounds tested are as follows: Cholesterol—1% in ethanol, 0.1 ml per detection device (1 mg a.i.); 2-Heptanone—1% in ethanol, 0.1 ml per detection device (1 mg a.i.); and 2-Heptanone oxime—1% in ethanol, 0.1 ml per detection device (1 mg a.i.).

TABLE 2

| Box | Device | Cholesterol | 2-Heptanone | 2-Heptanone-oxime |
|---|---|---|---|---|
| 1 | A | 1.0 mg | | |
| | B | 1.0 mg | 1.0 mg | 1.0 mg |
| | C | — | — | — |
| 2 | A | | 1.0 mg | |
| | B | 1.0 mg | 1.0 mg | 1.0 mg |
| | C | — | — | — |
| 3 | A | | | 1.0 mg |
| | B | 1.0 mg | 1.0 mg | 1.0 mg |
| | C | — | — | — |
| 4 | A | 1.0 mg | 1.0 mg | |
| | B | 1.0 mg | 1.0 mg | 1.0 mg |
| | C | — | — | — |

A = Single compounds and the combination of 2-Heptanone and 2-Heptanone-oxime (1:1)
B = Combination of cholesterol, 2-Heptanone, and 2-Heptanone-oxime (1:1:1)
C = untreated control (“UTC”)

The number of bed bugs in the different devices and on the bottom of the arenas were counted at day 1, day 4, and day 7 after the start of the trial. The total number of bugs per arena was 20.

The relative effectiveness of cholesterol, 2-Heptanone, and 2-Heptanone-oxime in attracting, arresting, or aggregating bed bugs was evaluated in Table 3.

TABLE 3

| | | | Mixture of cholesterol, | | Bottom |
|---|---|---|---|---|---|
| | | | 2-Heptanone, and | | of the |
| Box | Day | Compounds | 2-Heptanone-oxime | UTC | arena |
| 1 | | Cholesterol | | | |
| | 1 | 1 | 0 | 2 | 17 |
| | 4 | 1 | 0 | 2 | 17 |
| | 7 | 1 | 0 | 2 | 17 |
| 2 | | 2-Heptanone | | | |
| | 1 | 2 | 2 | 0 | 16 |
| | 4 | 2 | 3 | 0 | 15 |
| | 7 | 2 | 3 | 0 | 15 |
| 3 | | 2-Heptanone- | | | |
| | | Oxime | | | |
| | 1 | 13 | 0 | 0 | 7 |
| | 4 | 13 | 0 | 0 | 7 |
| | 7 | 13 | 0 | 0 | 7 |
| 4 | | 2-Heptanone- | | | |
| | | oxime + | | | |
| | | 2-Heptanone | | | |
| | 1 | 7 | 0 | 0 | 13 |
| | 4 | 7 | 0 | 0 | 13 |
| | 7 | 7 | 0 | 0 | 13 |

As set forth in Table 4, the ability of 2-Heptanone and 2-Heptanone-oxime to attract bed bugs at a concentration of 0.1 mg and 0.5 mg was evaluated. Device (A) includes 2-Heptanone, 2-Heptanone oxime, or both 2-Heptanone and 2-Heptanone oxime. Device (B) served as an untreated control.

TABLE 4

| Box | Device | 2-Heptanone | 2-Heptanone-oxime |
|---|---|---|---|
| 1 | A | 0.5 mg | |
| | B | | |
| 2 | A | 0.1 mg | |
| | B | | |
| 3 | A | | 0.5 mg |
| | B | | |
| 4 | A | | 0.1 mg |
| | B | | |
| 5 | A | 0.1 mg | 0.1 mg |
| | B | | |

A = Detection device treated with 2-Heptanone or 2-Heptanone-oxime
B = Untreated control

The numbers of bed bugs in the different devices and on the bottom of the arenas were counted at day 1, day 4, and day 6 after the start of the trial in Table 5. The total number of bugs per arena was 20.

TABLE 5

| | | | | Bottom |
|---|---|---|---|---|
| | | | | of the |
| Box | Day | Compounds + concentrations | UTC | arena |
| 1 | | 2-Heptanone 0.5 mg | | |
| | 1 | 0 | 1 | 19 |
| | 3 | 0 | 1 | 19 |
| | 6 | 1 | 3 | 16 |
| 2 | | 2-Heptanone 0.1 mg | | |
| | 1 | 0 | 0 | 20 |
| | 3 | 0 | 0 | 20 |
| | 6 | 1 | 2 | 17 |
| 3 | | 2-Heptanone-oxime 0.5 mg | | |
| | 1 | 8 | 0 | 12 |
| | 3 | 11 | 1 | 8 |
| | 6 | 12 | 0 | 8 |
| 4 | | 2-Heptanone-oxime 0.1 mg | | |
| | 1 | 12 | 1 | 7 |
| | 3 | 14 | 2 | 4 |
| | 6 | 15 | 1 | 4 |
| 5 | | 2-Heptanone-oxime 0.1 mg + | | |
| | | 2-Heptanone 0.1 mg | | |
| | 1 | 1 | 0 | 19 |
| | 3 | 3 | 0 | 17 |
| | 6 | 1 | 2 | 17 |

Having disclosed the instant subject matter, it should be apparent that many modifications, substitutions and variations of the present invention are possible in light thereof. It is to be understood that the present invention can be practiced other than as specifically described. Such modifications, substitutions and variations are intended to be within the scope of the present application. As used herein and in the following claims, articles such as “a”, “the” and so on can connote the singular or the plural of the object following.

What is claimed:

1. A method for detecting the presence or absence of an insect in an area, comprising providing in said area at least one compound of Formula (I): 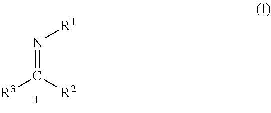
in which,
R¹ represents H, OH, NH₂, substituted or non substituted O—C₁-C₃-alkyl, substituted or non substituted O—C₁-C₆-alkyl, substituted or non substituted C₁-C₆-alkyl, N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃;
R² and R³ are independently selected from H, methyl, ethyl, propyl, isopropyl, cyclopropyl, butyl, tert-butyl, pentyl, tert-butyl, pentyl, hexyl, heptyl, octyl, nonyl, decyl, OH, COOH, substituted or non substituted C₂-C₁₂-alkyl, substituted or non substituted C₂-C₁₂-alkenyl, substituted or non substituted C₂-C₁₂-alkynyl, substituted or non substituted C₃-C₈-cycloalkyl, allyl, O-allyl, C₁-C₁₂-halogenalkyl, a halogen, tri-fluoromethyl, monohalo, polyhalo, perhaloalkyl, substituted or non substituted C₂-C₁₂-alkenyl, substituted or non substituted C₂-C₆-alkynyl, or where R² and R³ are linked together to form a (CH₂)₃, (CH₂)₄, (CH₂)₅, (CH₂)₆, (CH₂)₇, or a (CH₂)₈ ring structure; and/or
optically active and/or geometric isomers and/or salts thereof.

2. The method according to claim 1, in which
R¹ represents H, OH, NH₂, substituted or non substituted O—C₁-C₃-alkyl, or substituted or non substituted O—C₁-C₆-alkyl;
R² and R³ are independently selected from H, methyl, ethyl, propyl, isopropyl, butyl, tert-butyl, pentyl, substituted or non substituted C₂-C₆-alkyl, substituted or non substituted C₂-C₆-alkenyl, a substituted or non substituted C₂-C₆-alkynyl substituted or non substituted C₃-C₆-cycloalkyl, allyl; O-allyl; C₁-C₆-halogenalkyl, monohalo, polyhalo, perhaloalkyl, a halogen, trifluoromethyl, substituted or non substituted C₂-C₆-alkenyl, substituted or non substituted C₂-C₆-alkynyl; or where R² and R³ are linked together to form a (CH₂)₃, (CH₂)₄, (CH₂)₅, (CH₂)₆, (CH₂)₇, or (CH₂)₈ ring structure; and/or
optically active and/or geometric isomers and/or salts thereof.

3. The method according to claim 1, in which
R¹ represents H, OH, or NH₂;
R² and R³ are independently selected from methyl, ethyl, propyl, isopropyl, butyl, tert-butyl, pentyl, hexyl, heptyl, octyl, or a substituted or non substituted C₂-C₁₂-alkyl; and/or
optically active and/or geometric isomers and/or salts thereof.

4. The method according to claim 1, in which
R¹ represents OH;
R² is methyl or tri-fluoromethyl;
R³ is propyl, butyl, tert-butyl, pentyl, hexyl, heptyl, octyl, or a substituted or non substituted C₂-C₁₂-alkyl; and/or
optically active and/or geometric isomers and/or salts thereof.

5. The method according to claim 1, in which
R¹ represents OH;
R² is methyl;
R³ is butyl, tert-butyl, pentyl, hexyl, heptyl, or octyl; and/or
optically active and/or geometric isomers and/or salts thereof.

6. The method according to claim 1, in which R¹ represents OH.

7. The method according to claim 1, in which R¹ represents H or NH₂.

8. The method according to claim 1, wherein said compound is selected from the group consisting of 2-heptanone oxime, 2-hexanone oxime, and 2-Nonanone oxime.

9. The method according to claim 1, wherein said compound is present in a composition that comprises from about 100 ng to about 10 mg of 2-Heptanone-oxime, from about 0.100 ng to about 10 mg of 2-hexanone oxime, or from about 100 ng to about 10 mg 2-Nonanone oxime.

10. The method according to claim 1, wherein said compound is present in a composition comprises from about 100 ng to about 10 mg of 2-Heptanone-oxime and about 0.01 mg to about 10 ng cholesterol.

11. The method according to claim 1, wherein said compound is present in a composition that further comprises diatomaceous earth and/or silica gel.

12. The method according to claim 1, wherein said compound is present in a composition that further comprises a compound selected from the group consisting of cholesterol, (E)-2-hexenal, (E)-2-hexenol, (E,E)-2,4-hexadienal, and (E)-2-octenal.

13. The method according to claim 1, wherein said compound is provided in a device that has an internal volume and an opening sized to permit entry into the detection device by one or more insects.

14. The method according to claim 13, wherein said device comprises an absorbant material impregnated with said compound.

15. The method according to claim 1, wherein said compound is present in a composition that further comprises an insecticide.

16. The method according to claim 15, wherein said composition is a bait composition.

17. The method according to claim 1, wherein said insect is a bed bug.

18. A composition capable of attracting, arresting, aggregating, or altering the behavior of an insect comprising a compound of Formula (I): 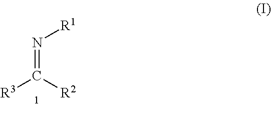
in which, R¹ represents H, OH, NH₂, substituted or non substituted O—C₁-C₃-alkyl, substituted or non substituted O—C₁-C₆-alkyl, N-methyl, N-ethyl, N-Propyl, N—C₁-C₆-alkyl, N,N-dimethyl,N,N-dialkyl, N—NO₂, N—CN, SO₃H, substituted or non-substituted S(O)—C₁-C₆-alkyl, substituted or non-substituted S—C₁-C₆-alkyl, SH, substituted or non-substituted S(O)₂—C₁-C₆-alkyl, S(O)₂OH, substituted or non-substituted S(O)₂O—C₁-C₆-alkyl, PH₃, P(C₁-C₆-alkyl)₃;
R² and R³ are independently selected from H, methyl, ethyl, propyl, isopropyl, cyclopropyl, butyl, tert-butyl, pentyl, tert-butyl, pentyl, hexyl, heptyl, octyl, nonyl, decyl, substituted or non substituted C₂-C₁₂-alkyl, substituted or non substituted C₂-C₁₂-alkenyl, substituted or non substituted C₂-C₁₂-alkynyl, substituted or non substituted C₃-C₈-cycloalkyl, allyl, O-allyl, C₁-C₁₂-halogenalkyl, a halogen, tri-fluoromethyl, monohalo, polyhalo, perhaloalkyl, substituted or non substituted C₂-C₁₂-alkenyl, substituted or non substituted C₂-C₆-alkynyl, or where R² and R³ are linked together to form a (CH₂)₃, (CH₂)₄, (CH₂)₅, (CH₂)₆, (CH₂)₇, or (CH₂)₈ ring structure; and/or an
optically active and/or geometric isomers and/or salts thereof.

19. A method of attracting, aggregating, arresting, detecting, controlling, and/or treating insect infestation in an area comprising providing in said area, a compound selected from the group consisting of 2-heptanone oxime, 2-octanone oxime, 2-hexanone oxime, 4-heptanone oxime, 3-octanone oxime, 3-hexanone oxime, 3-heptanone oxime, 2-heptanone imine and salts thereof, 2-pentanone oxime, 2-pentanone hydrazone, 5-methyl-2-hexanone hydrazone, 2-heptanone O-methoxyimine, 5-methyl-2-hexanone oxime, 2-methyl-3-hexanone oxime, 5-methyl-2-hexene-2-one, cyclohexanone oxime, cyclohexanone hydrazone, cycloheptanone oxime, cycloheptanone hydrazone, 2-Pentanone hydrazone, 3-pentanone hydrazone, 2-hexanone hydrazone, 3-hexanone hydrazone, 2-heptanone hydrazone, 3-heptanone hydrazone, 2-heptanone hydrazone, 3-heptanone hydrazone, 4-heptanone hydrazone, 2-octanone hydrazone, 3-octanone hydrazone, 4-octanone hydrazone, 3-octanone oxime, 2-nonanone hydrazone, 3-nonanone hydrazone, 4-nonanone hydrazone, 5-nonanone hydrazone, 2-nonanone oxime, 3-nonanone oxime, 4-nonanone oxime, 5-nonanone oxime, 2-octanone oxime, 2-propanone O-methyloxime, 1-cyclopropyl-2-heptanone oxime, 1-cyclopropyl-2-heptanone hydrazone, N-(1-Methylpentylidene)methylamine, N-(1-Methylhexylidene)methylamine, (Z) 2-Hexanone, 3-methyl-, oxime, (E), 2-hexanone, 3-methyl-, oxime, 2-pentanone 3-ethyl-oxime, 2-pentanone, 3,4-dimethyl-oxime, N-methyl pentanimidamide, urea, 1,2,4,5-tetrazine dicarboxamide, and/or 1,2-Hydrazindicarboxamide.

20. The method of claim 19, wherein said insect infestation is bed bug infestation.
